(19) United States
(12) Patent Application Publication
(10) Pub. No.: US 2025/0140495 A1
(43) Pub. Date: May 1, 2025

(54) DUAL-SWITCH HOUSING

(71) Applicant: Milspec Enterprises, LLC, Panorama City, CA (US)

(72) Inventor: Yosef Rosenbaum, Los Angeles, CA (US)

(73) Assignee: Milspec Enterprises, LLC, Panorama City, CA (US)

(21) Appl. No.: 18/929,506

(22) Filed: Oct. 28, 2024

Related U.S. Application Data
(60) Provisional application No. 63/545,769, filed on Oct. 26, 2023.

(51) Int. Cl. H01H 13/86; H01H 13/14; H01H 13/7057; H01H 13/85

(52) U.S. Cl. CPC H01H 13/86; H01H 13/14; H01H 13/7057; H01H 13/85; H01H 2223/02; H01H 2223/024

(57) ABSTRACT

The dual-switch housing is configured to secure two separate switches on a rail interface system and includes an actuator that allows an end-user to activate both switches individually or simultaneously. An example dual-switch housing comprises: a housing including rail clamp portions for removably mounting the dual-switch housing to the rail interface system; and an actuator configured to actuate the first and second switches individually or simultaneously. The actuator comprises a first actuation button configured to actuate only the first switch, a second actuation button configured to actuate both the first switch and the second switch, and a third actuation button configured to actuate only the second switch.

### CROSS-REFERENCE TO RELATED APPLICATION(S)

This application claims the benefit of U.S. Provisional Application Ser. No. 63/545,769, filed on Oct. 26, 2023, the entirety of which is incorporated herein by reference.

### TECHNICAL FIELD

This disclosure relates to implementations of a dual-switch housing. In particular, the present disclosure is directed to a housing configured to secure two separate switches on a rail interface system. The housing includes an actuator that allows an end-user to activate both switches individually or simultaneously.

### BACKGROUND

Remote switches for firearm-mounted accessories are used to operate lights and lasers without needing to reach for each device directly. Typically mounted on a rail interface system, remote switches are positioned for quick, ergonomic activation of any connected device. Remote switches that provide momentary-only and/or constant-on activation of connected devices are well known in the prior art. Some remote switches support single or dual device activation, enhancing flexibility for tactical use. Remote switches contribute to convenience and operational efficiency, especially in dynamic environments.

Accordingly, there exists a need for the dual-switch housing disclosed herein. The present invention is primarily directed towards providing a dual-switch housing configured to address these and other needs.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

A dual-switch housing is configured to secure two separate switches on a rail interface system and includes an actuator that allows an end-user to activate both switches individually or simultaneously. The example dual-switch housing is configured to secure two ModButton™ Lite switches to a MIL-STD-1913 Picatinny rail. Each switch includes a momentary-only pressure switch connected to a plug by a cable. Although the example dual-switch housing is configured for use with ModButton™ Lite switches, it may be configured for use with other remote switches.

An example dual-switch housing comprises: a housing including rail clamp portions for removably mounting the dual-switch housing to the rail interface system; and an actuator configured to actuate the first and second switches individually or simultaneously. The actuator comprises a first actuation button configured to actuate only the first switch, a second actuation button configured to actuate both the first switch and the second switch, and a third actuation button configured to actuate only the second switch.

Another example dual-switch housing comprises: a housing including rail clamp portions for removably mounting the dual-switch housing to the rail interface system; and an actuator configured to actuate the first and second switches individually or simultaneously, the actuator being connected to the housing by a flexible arm configured to facilitate both vertical and rotational movement of the actuator. The actuator comprises a first actuation button configured to actuate only the first switch, a second actuation button configured to actuate both the first switch and the second switch, and a third actuation button configured to actuate only the second switch.

Yet another example dual-switch housing comprises: a housing including rail clamp portions for removably mounting the dual-switch housing to the rail interface system; and an actuator configured to actuate the first and second switches individually or simultaneously, the actuator being connected to the housing by an elastic membrane configured to facilitate both vertical and rotational movement of the actuator. The actuator comprises a first actuation button configured to actuate only the first switch, a second actuation button configured to actuate both the first switch and the second switch, and a third actuation button configured to actuate only the second switch.

### BRIEF DESCRIPTION OF THE DRAWINGS

FIGS. 1 and 2 are isometric views of a dual-switch housing, according to the principles of the present disclosure, securing two switches to a rail interface system.

FIG. 3 is a rear elevational view of the dual-switch housing, switches, and rail interface system shown in FIGS. 1 and 2.

FIG. 4 is a side cutaway view of the dual-switch housing, switches, and rail interface system, taken along lines 4-4 shown in FIG. 3.

FIG. 5 is a right side elevational view of the dual-switch housing, switches, and rail interface system shown in FIGS. 1 and 2.

FIG. 6 is a side cutaway view of the dual-switch housing, switches, and rail interface system, taken along lines 6-6 shown in FIG. 5.

FIG. 7 is an exploded isometric view of the dual-switch housing, switches, and rail interface system shown in FIGS. 1 and 2.

FIG. 8 is an isometric view of the right side piece and actuator of the dual-switch housing shown in FIG. 1.

FIG. 9 is a side elevational view of the right side piece and actuator shown in FIG. 8.

FIGS. 10 and 11 are isometric views of another dual-switch housing according, to the principles of the present disclosure.

FIG. 12 is a front elevational view of the dual-switch housing shown in FIGS. 10 and 11.

FIG. 13 is a right side elevational view of the dual-switch housing shown in FIGS. 10 and 11.

FIG. 14 is a bottom plan view of the dual-switch housing shown in FIGS. 10 and 11.

FIG. 15 is a rear elevational view of the dual-switch housing shown in FIGS. 10 and 11.

FIG. 16 is a side cutaway view of the dual-switch housing, taken along lines 16-16 shown in FIG. 15.

FIG. 17 is another right side elevational view of the dual-switch housing shown in FIGS. 10 and 11.

FIG. 18 is a side cutaway view of the dual-switch housing, taken along lines 18-18 shown in FIG. 17.

Like reference numerals refer to corresponding parts throughout the several views of the drawings.

### DETAILED DESCRIPTION

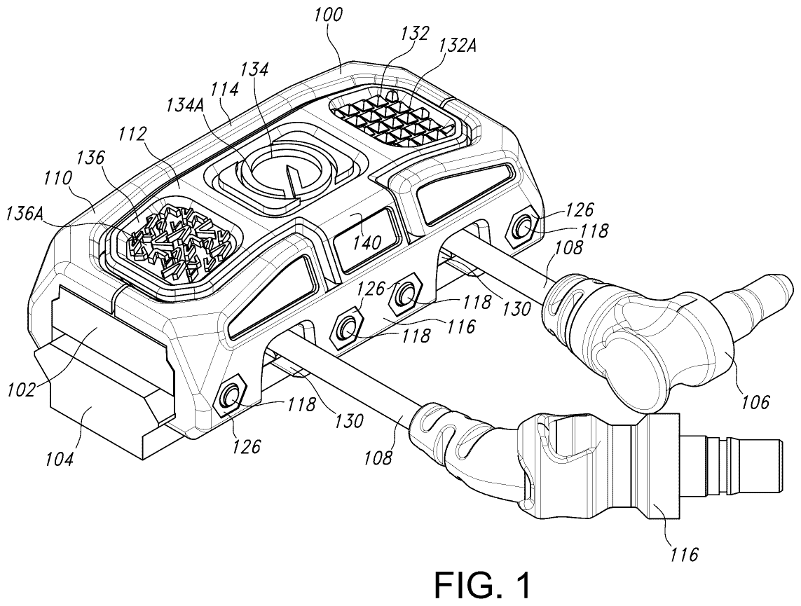

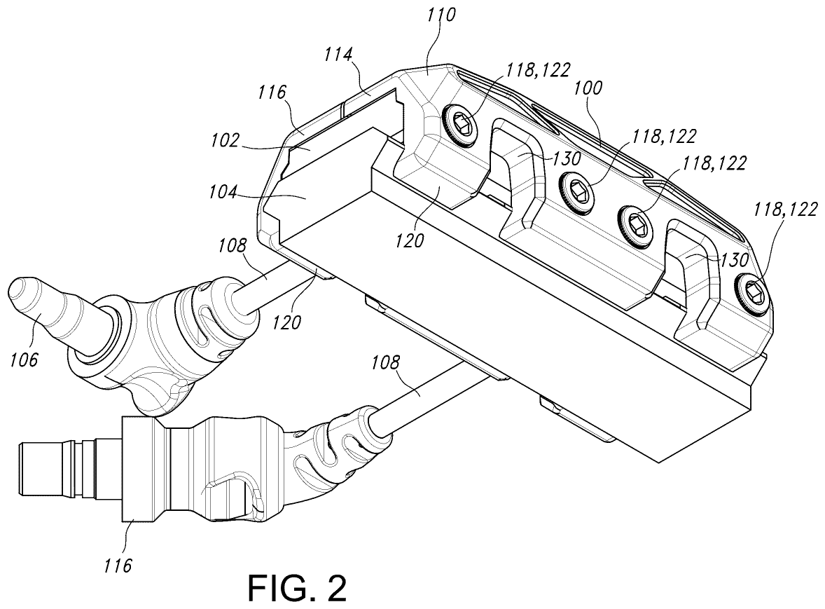

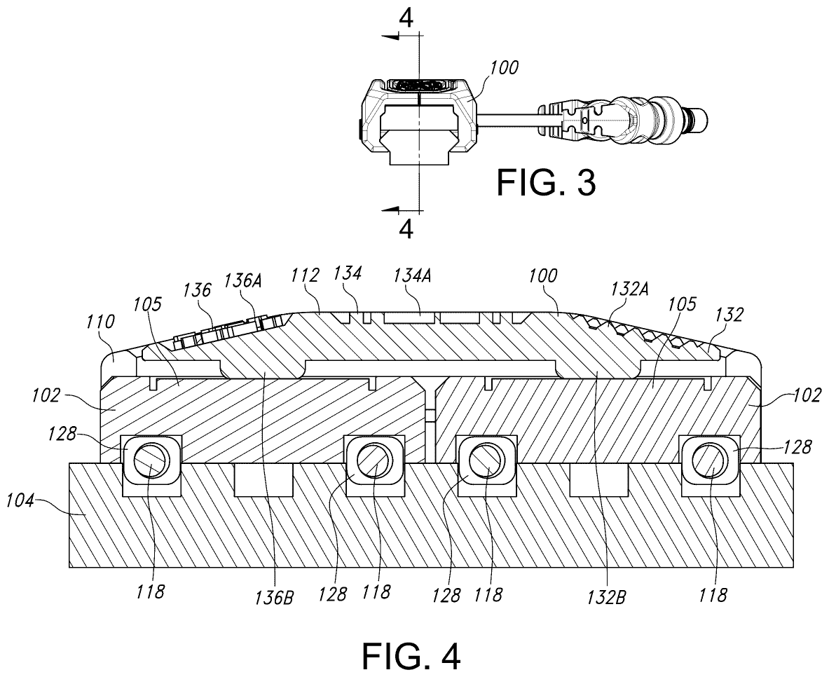

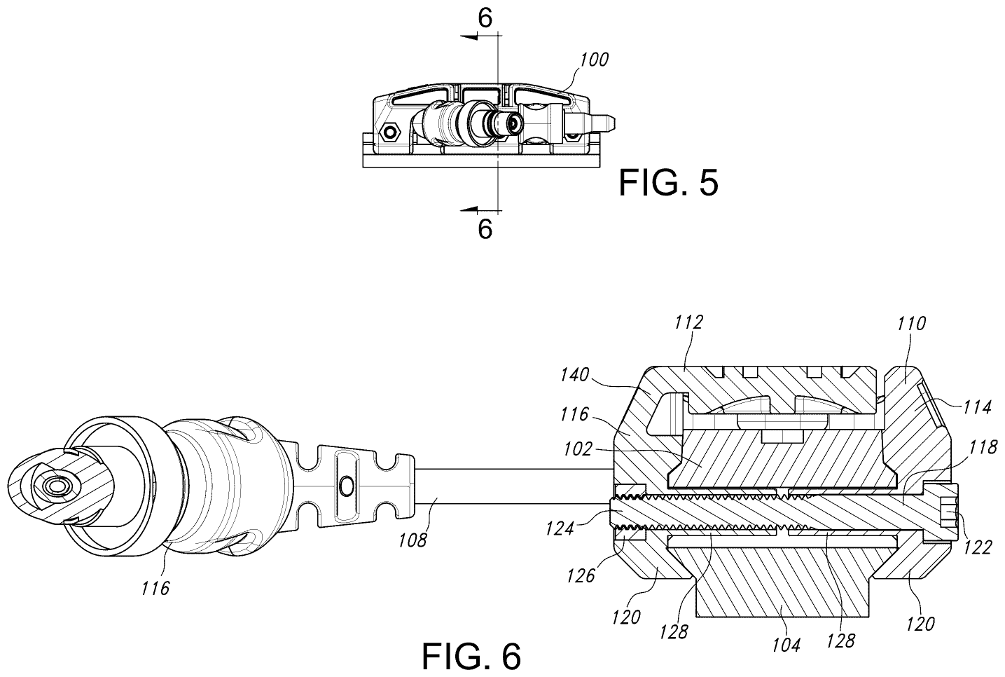

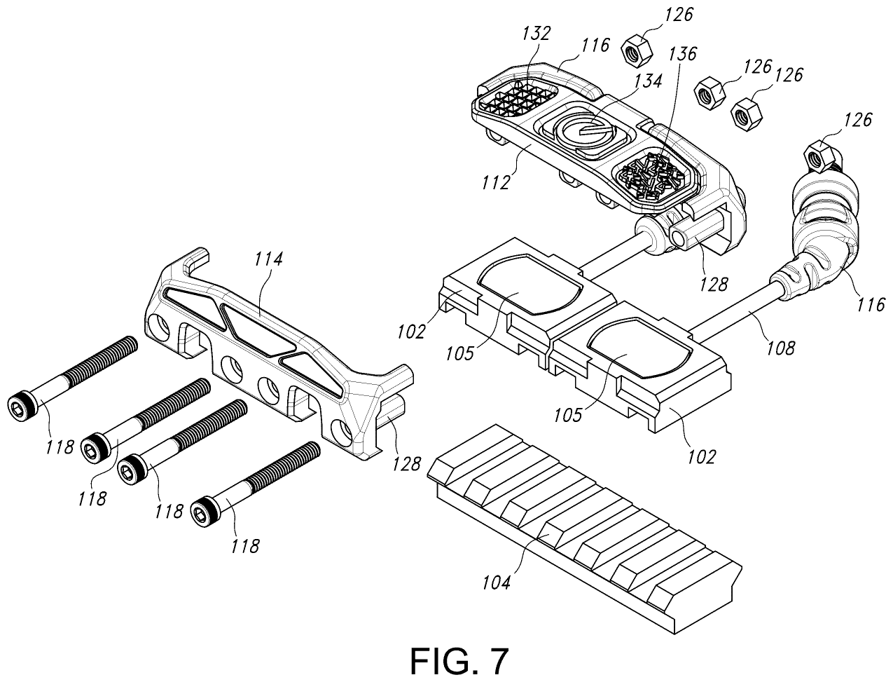

FIGS. 1-6 illustrate a dual-switch housing 100, according to the principles of the present disclosure. The dual-switch housing 100 is configured to secure two separate switches 102 on a rail interface system 104 and includes an actuator 112 configured to allow an end-user to activate both switches 102 individually or simultaneously. The example dual-switch housing 100 is configured to secure two ModButton™ Lite switches 102 to a MIL-STD-1913 Picatinny rail. Each switch 102 includes a momentary-only pressure switch 105 connected to a plug 106 by a cable 108. Although the example dual-switch housing 100 is configured for use with ModButton™ Lite switches 102, the dual-switch housing 100 may be configured for use with other remote switches.

The dual-switch housing 100 comprises a housing 110 and an actuator 112.

The housing 110 includes two side pieces (114, 116) joined by threaded fasteners 118. Each side piece (114, 116) includes a cutout 130 through which the cable 108 of the adjacent switch 102 can extend, provided the switch 102 is oriented correctly (see, e.g., FIG. 1). This configuration allows the end-user to position each switch 102 so that the cable can extend from either the left or right side of the housing 110.

The housing 110 includes rail clamp portions 120 used in conjunction with the threaded fasteners 118 to fixedly clamp the dual-switch housing 100 to the rail interface system 104. Each threaded fastener 118 extends laterally and transversely through lateral openings in the left and right side pieces 114, 116 of the housing 110 (see, e.g., FIG. 6). The head 122 of each fastener 118 is positioned in a counterbore in one side piece 114 of the housing 110, and the threaded end 124 of the fastener 118 extends through the other side piece 116 of the housing 110 to removably couple with a threaded hex nut 126 positioned in a recess. The bolt head 122 and hex nut 126 may alternatively be reversed in position on the opposite sides (114, 116) of the housing 110. The housing 110 is coupled to the rail interface system 104 by tightening each of the threaded fasteners 118. This laterally compresses and draws the rail clamp portions 120 together, thereby fixedly clamping the housing 110 to the rail interface system 104.

Recoil lugs 128 extend from an interior side of each side piece (114, 116) of the housing 110. In the preferred embodiment, each side piece (114, 116) includes four recoil lugs 128. Each recoil lug 128 defines an interior bore through which a portion of a threaded fastener 118 extends when the housing 110 is assembled (see, e.g., FIG. 6). The recoil lugs 128 are configured (e.g., dimensioned) to be received in grooves defined by the rail interface system 104 (see, e.g., FIG. 4). In this way, the housing 110 is better able to resist longitudinal displacement. In the preferred embodiment, each recoil lug 128 is an elongated member with a rectangular cross-section.

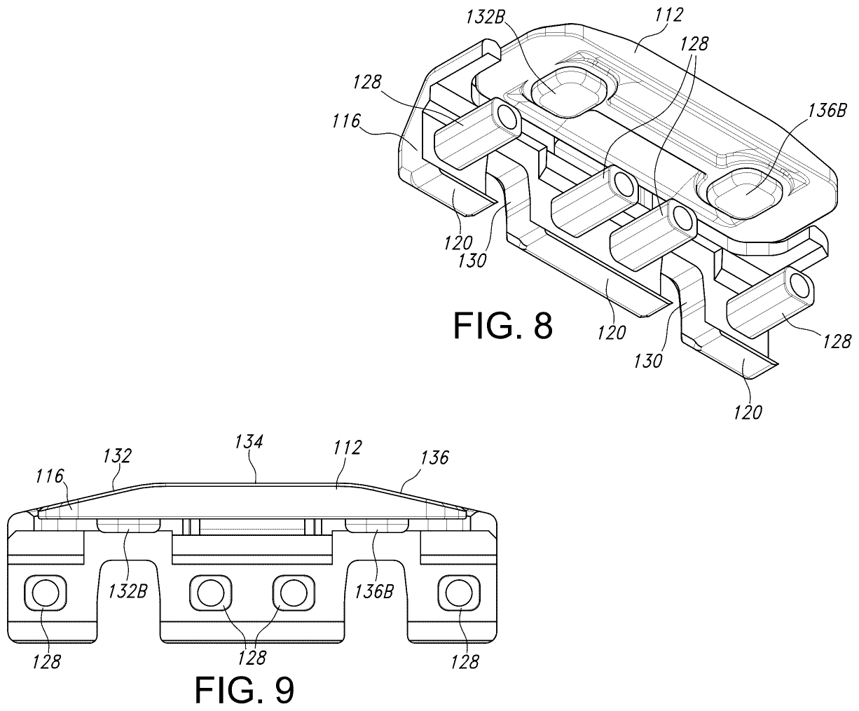

The actuator 112 of the dual-switch housing 100 can be used to actuate each switch 102 individually or both switches 102 simultaneously. The actuator 112 comprises three actuation buttons (132, 134, 136). In some implementations, each of the three actuation buttons (132, 134, 136) has a unique tactile feel, angle, or both, allowing the end-user to differentiate each actuation button from the others. The forward and rear actuation buttons (132, 136) are configured to actuate only the underlying switch 102, while the middle actuation button 134 is configured to actuate both switches 102 simultaneously. The three actuation buttons (132, 134, 136) are positioned in a linear arrangement. The front actuation button 132 extends downward at an angle from one end of the middle actuation button 134, and the rear actuation button 136 extends downward at an angle from the opposite end of the middle actuation button 134. Each of the three actuation buttons (132, 134, 136) comprises a tactile pad (132A, 134A, 136A). The forward and rearward actuation buttons (132, 136) each further comprise a contact interface (132B, 136B) positioned opposite the tactile pad (132A, 136A). The contact interface (132B, 136B) of the forward and rearward actuation buttons (132, 136) is a protuberance with a generally rectangular and flat contact surface (see, e.g., FIG. 8). However, the contact interface (132B, 136B) could be any shape suitable for actuating an underlying switch 102.

The actuator 112 is connected to the right side piece 116 of the housing 110 by a flexible arm 140. In the preferred embodiment, the actuator 112 and arm 140 are an integral part of the right side piece 116. The arm 140 is configured to facilitate both vertical movement and rotational movement of the actuator 112. Thus, depending on the actuation button (132, 134, 136) depressed by the end-user, the actuator 112 can individually actuate the two underlying switches 102 or simultaneously actuate both underlying switches 102.

### Operation and Use

As an example, the arm 140 is configured so that depressing the forward actuation button 132 causes the actuator 112 to rotate forward and move down until the contact portion 132B actuates the underlying switch 102.

As another example, the arm 140 is configured so that depressing the middle actuation button 134 causes the actuator 112 to move down until both contact portions (132B, 136B) actuate their respective underlying switch 102.

As yet another example, the arm 140 is configured so that depressing the rearward actuation button 136 causes the actuator 112 to rotate rearward and move down until the contact portion 162B actuates the underlying switch 102.

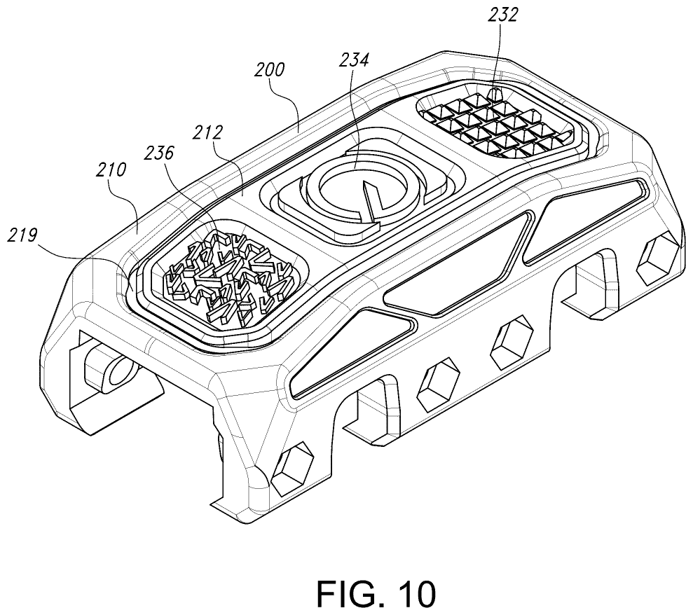

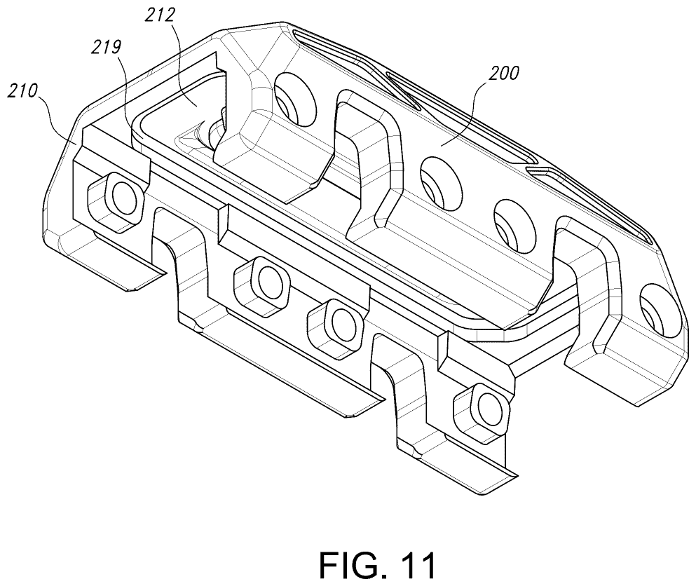

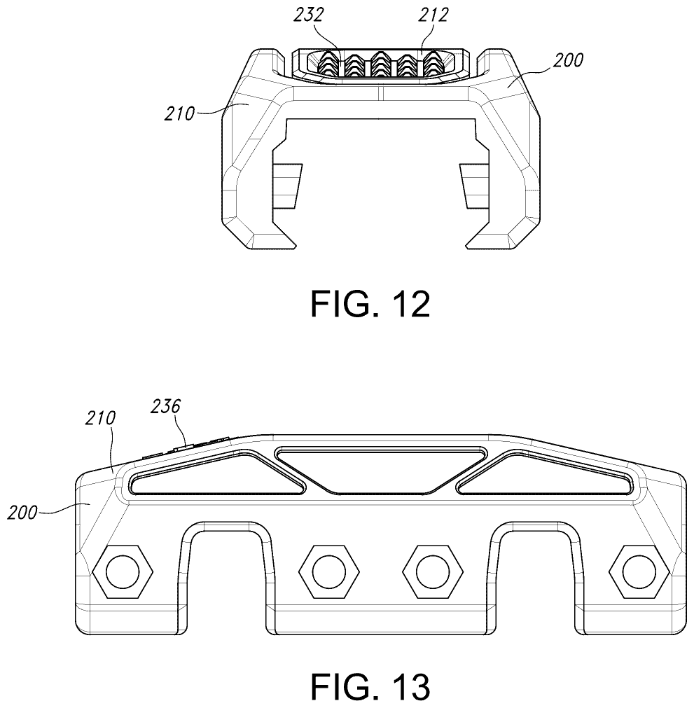

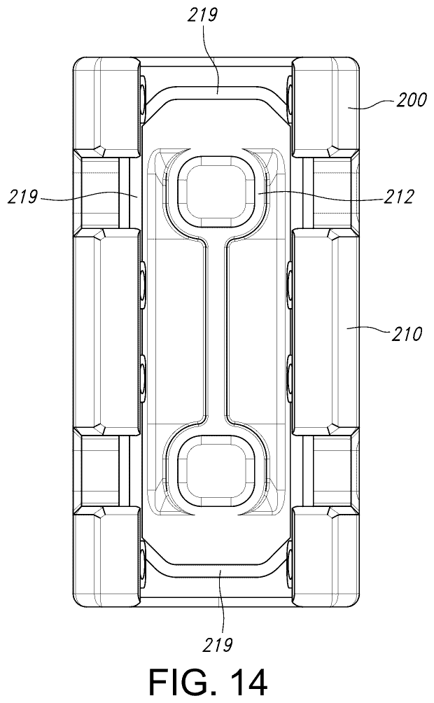

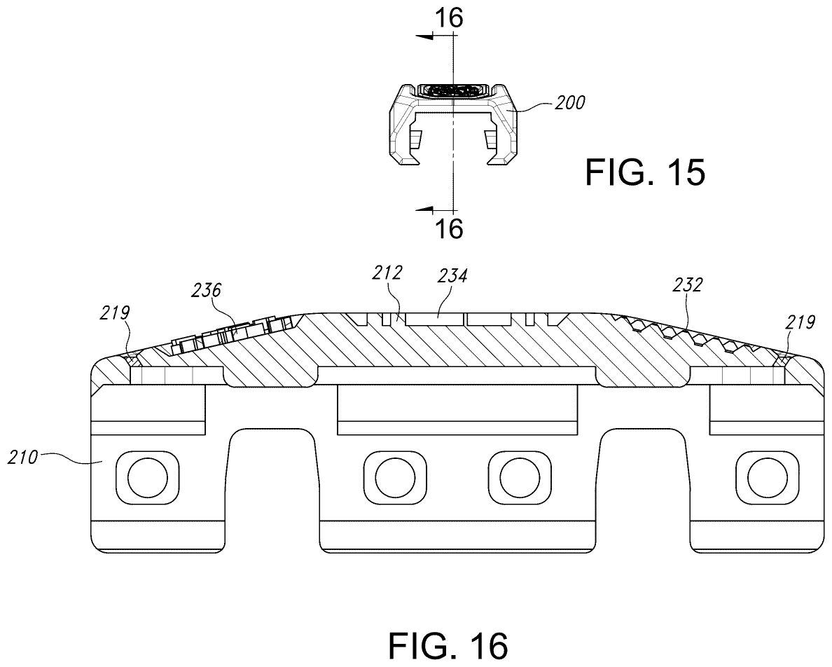

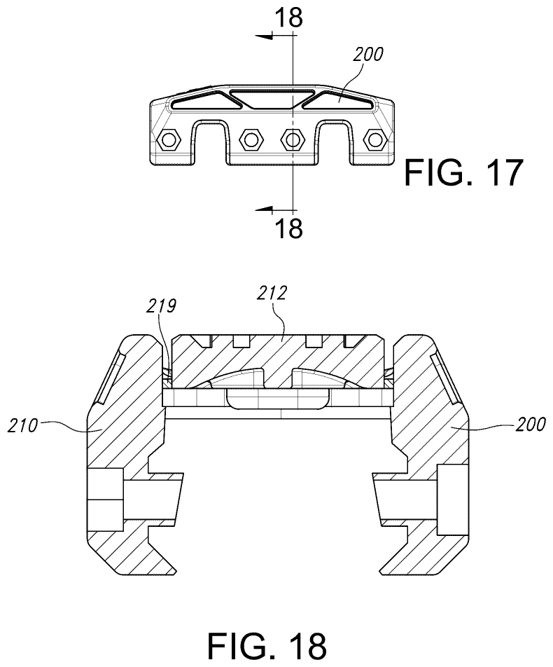

FIGS. 10-18 illustrate another example dual-switch housing 200, according to the principles of the present disclosure. The dual-switch housing 200 is similar to the dual-switch housing 100 discussed above, but the actuator 212 is held in position by an elastic membrane 219.

The housing 210 is a single, unitary piece that can be secured to the rail interface 104 using a combination of threaded fasteners 118 and hex nuts 126, as described above. The actuator 212 is held in position within an opening in a top side of the housing 210 by an elastic membrane 219. In some embodiments, the elastic membrane 219 extends between the perimeter edge of the actuator 212 and the interior edge of the opening defined by the housing 210. The elastic membrane 219 is configured to resiliently deform and stretch when any of the actuation buttons (232, 234, 236) are depressed. In some implementations, the elastic membrane 219 is made of an elastomeric material.

The housing (110, 210) and actuator (112, 212) of the dual-switch housing (100, 200) are fabricated from nylon. However, the housing (110, 210) and/or actuator (112, 212) could be fabricated from another suitably resilient material.

The threaded fasteners 118 and hex nuts 126 are fabricated from a steel alloy. However, the threaded fasteners 118 and hex nuts 126 could also be fabricated from another relatively strong and lightweight material, such as an aluminum or titanium alloy.

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A dual-switch housing configured to secure a first switch and a second switch to a rail interface system, the dual-switch housing comprising:
a housing including rail clamp portions for removably mounting the dual-switch housing to the rail interface system; and
an actuator configured to actuate the first and second switches individually or simultaneously;
wherein the actuator comprises:
a first actuation button configured to actuate only the first switch;
a second actuation button configured to actuate both the first switch and the second switch; and
a third actuation button configured to actuate only the second switch.

2. The dual-switch housing of claim 1, wherein the first actuation button, the second actuation button, and the third actuation button are positioned in a linear arrangement.

3. The dual-switch housing of claim 2, wherein the first actuation button extends downward at an angle from one end of the second actuation button, and the third actuation button extends downward at an angle from the opposite end of the second actuation button.

4. The dual-switch housing of claim 3, wherein the first and third actuation buttons each comprise a tactile pad and a contact interface positioned opposite the tactile pad, and the second actuation button comprises a tactile pad.

5. A dual-switch housing configured to secure a first switch and a second switch to a rail interface system, the dual-switch housing comprising:
a housing including rail clamp portions for removably mounting the dual-switch housing to the rail interface system; and
an actuator configured to actuate the first and second switches individually or simultaneously, the actuator being connected to the housing by a flexible arm configured to facilitate both vertical and rotational movement of the actuator;
wherein the actuator comprises:
a first actuation button configured to actuate only the first switch;
a second actuation button configured to actuate both the first switch and the second switch; and
a third actuation button configured to actuate only the second switch.

6. The dual-switch housing of claim 5, wherein the first actuation button, the second actuation button, and the third actuation button are positioned in a linear arrangement.

7. The dual-switch housing of claim 6, wherein the first actuation button extends downward at an angle from one end of the second actuation button, and the third actuation button extends downward at an angle from the opposite end of the second actuation button.

8. The dual-switch housing of claim 7, wherein the first and third actuation buttons each comprise a tactile pad and a contact interface positioned opposite the tactile pad, and the second actuation button comprises a tactile pad.

9. A dual-switch housing configured to secure a first switch and a second switch to a rail interface system, the dual-switch housing comprising:
a housing including rail clamp portions for removably mounting the dual-switch housing to the rail interface system; and
an actuator configured to actuate the first and second switches individually or simultaneously, the actuator being connected to the housing by an elastic membrane configured to facilitate both vertical and rotational movement of the actuator;
wherein the actuator comprises:
a first actuation button configured to actuate only the first switch;
a second actuation button configured to actuate both the first switch and the second switch; and
a third actuation button configured to actuate only the second switch.

10. The dual-switch housing of claim 9, wherein the first actuation button, the second actuation button, and the third actuation button are positioned in a linear arrangement.

11. The dual-switch housing of claim 10, wherein the first actuation button extends downward at an angle from one end of the second actuation button, and the third actuation button extends downward at an angle from the opposite end of the second actuation button.

12. The dual-switch housing of claim 11, wherein the first and third actuation buttons each comprise a tactile pad and a contact interface positioned opposite the tactile pad, and the second actuation button comprises a tactile pad.
